(19) United States
(12) Patent Application Publication
(10) Pub. No.: US 2019/0059215 A1
(43) Pub. Date: Feb. 28, 2019

(54) CUTTER RETENTION ASSEMBLY

(71) Applicant: Diamond Mowers LLC, Sioux Falls, SD (US)

(72) Inventors: Dave Ver Steeg, Sioux Falls, SD (US); Shannon Newman, Tea, SD (US)

(73) Assignee: DIamond Mowers LLC, Sioux Falls, SD (US)

(21) Appl. No.: 16/109,139

(22) Filed: Aug. 22, 2018

Related U.S. Application Data
(60) Provisional application No. 62/551,040, filed on Aug. 28, 2017.

(51) Int. Cl. A01D 34/73; A01D 34/82

(52) U.S. Cl. CPC A01D 34/733; A01D 34/828

(57) ABSTRACT

A cutter retention assembly includes a mowing deck coupled to a mower. A spindle, rotated by the mower, extends from the mower downwardly relative to a top wall of the mowing deck. A spindle housing extends from the mowing deck around the spindle with a coupling portion of the spindle extending from the spindle housing. A lip extends radially outward from the spindle outside of the spindle housing. A retainer is coupled to the spindle housing around the spindle defining a collar. The collar is positioned adjacent to and aligns with the lip such that the lip will be retained within the mowing deck by the collar upon catastrophic failure of the spindle. A cutter is coupled to the spindle, exposed in the mowing deck, and rotates with the spindle. The cutter is thus retained adjacent to the mowing deck upon the catastrophic failure of the spindle.

### CROSS-REFERENCE TO RELATED APPLICATIONS

We hereby claim the benefit under 35 U.S.C. Section 119(e) of U.S. Provisional application 62/551,040 filed Aug. 28, 2017.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to mower deck safety devices and more particularly pertains to a new mower deck safety device for preventing a cutter from flying away from a mower deck upon catastrophic spindle failure.

### BRIEF SUMMARY OF THE INVENTION

An embodiment of the disclosure meets the needs presented above by generally comprising a mowing deck coupled to a mower. A spindle, rotated by the mower, extends from the mower downwardly relative to a top wall of the mowing deck. A spindle housing extends from the mowing deck around the spindle with a coupling portion of the spindle extending from the spindle housing. A lip extends radially outward from the spindle outside of the spindle housing. A retainer is coupled to the spindle housing around the spindle defining a collar. The collar is positioned adjacent to and aligns with the lip such that the lip will be retained within the mowing deck by the collar upon catastrophic failure of the spindle. A cutter is coupled to the spindle, exposed in the mowing deck, and rotates with the spindle. The cutter is thus retained adjacent to the mowing deck upon the catastrophic failure of the spindle between the mower and the lip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a detailed cross-sectional view of a cutter retention assembly according to an embodiment of the disclosure.

FIG. 2 is a perspective view of an adapter of an embodiment of the disclosure.

FIG. 3 is a side view of an adapter of an embodiment of the disclosure.

FIG. 4 is a perspective view of a retainer of an embodiment of the disclosure.

### DETAILED DESCRIPTION OF THE INVENTION

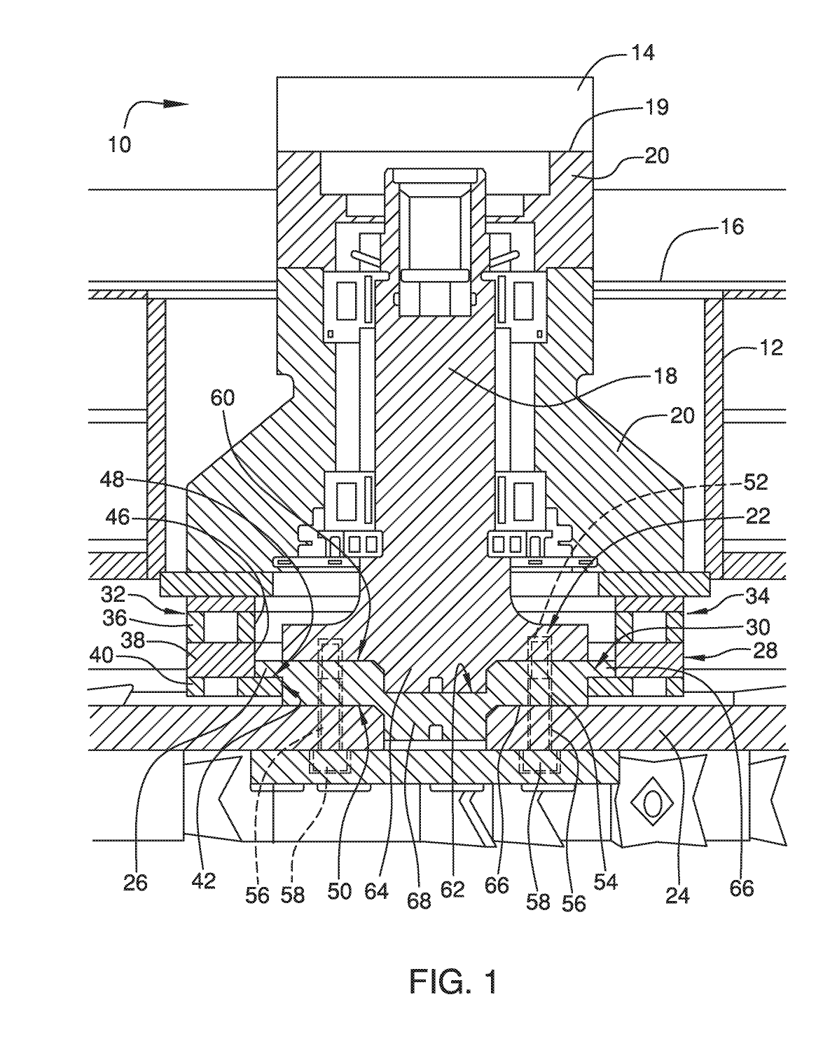

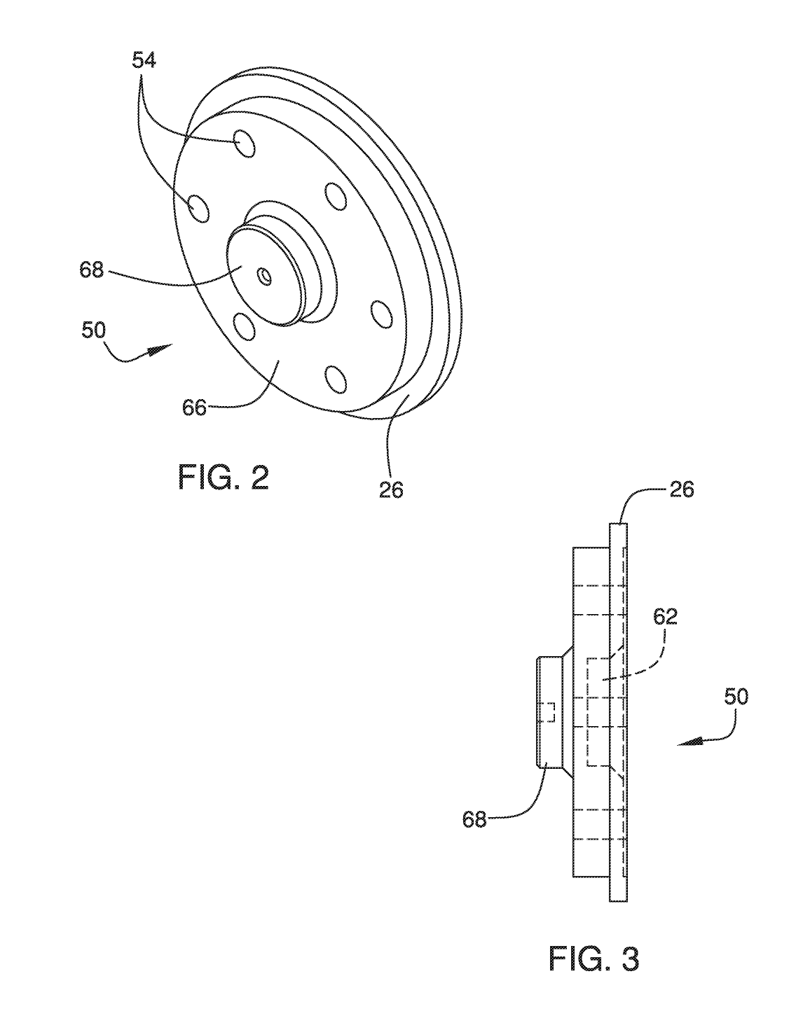

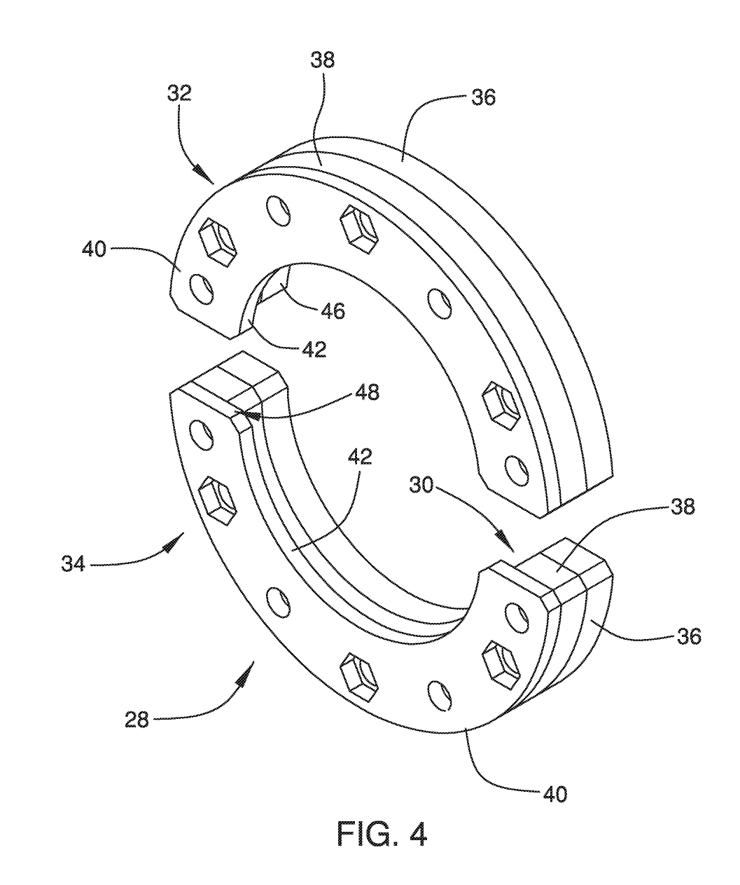

With reference now to the drawings, and in particular to FIGS. 1 through 4 thereof, a new mower deck safety device embodying the principles and concepts of an embodiment of the disclosure and generally designated by the reference numeral 10 will be described.

As best illustrated in FIGS. 1 through 4, the cutter retention assembly 10 generally comprises a mowing deck 12 having a top wall 16. A hydraulic motor 14 is positioned on a top 19 of a spindle housing 20 coupled to the mowing deck 12. A spindle 18 is coupled to the mowing deck 12 by the spindle housing 20 and rotated by the hydraulic motor 14. The hydraulic motor 14 may be power by a power take off or other conventional connection to a machine such as a tractor, skid steer, or the like. The spindle 18 extends downwardly relative to the top wall 16 of the mowing deck 12. The spindle housing 20 is coupled to the mowing deck 12 and extends around the spindle 18. The spindle 18 has a coupling portion 22 extending from the spindle housing 20. In a conventional assembly, the coupling portion 22 is attached directly to a cutter 24 such as a cutting disc, blade, or the like. The conventional direct attachment allows the cutter 24 to fly away from the mowing deck 12 upon catastrophic failure of the spindle 18. For purposes of the invention, a lip 26 is coupled to the spindle 18. The lip 26 extends radially outward relative to the spindle 18 and may be positioned outside of the spindle housing 20. A retainer 28 is coupled to the spindle housing 20. The retainer 28 extends around the spindle 18 defining a collar 30. The collar 30 is positioned adjacent to and aligns with the lip 26 such that the lip 26 is positioned to be retained within the mowing deck 12 by the collar 30 upon catastrophic failure of the spindle 18. Although the lip 26 is described above as being outside the spindle housing 20, this is contemplated primarily for application of the invention to a conventional existing mower 14. The invention may be incorporated into new equipment manufacture such that the retainer 28, if considered as a part or extension of the spindle housing 20, extends around the lip 26 and the lip 26 may be considered as being within the spindle housing 20.

The retainer 28 comprises a first arcuate section 32 and a second arcuate section 34 facilitating installation, repair, or replacement of the retainer 28 and other structures.

The first arcuate section 32 and the second arcuate section 34 are positioned to define the collar 30 extending around the spindle 18. Each of the first arcuate section 32 and the second arcuate section 34 comprises a respective top plate 36, middle plate 38, and bottom plate 40. The three plate assembled structure is employed for efficiency and economy of production based on the thickness of the material used. The bottom plate 40 of each of the first arcuate section 32 and the second arcuate section 34 has a concave interior edge 42 which is inset relative to concave interior edges 46 of the middle plate 38 and the top plate 36 of each of the first arcuate section 32 and the second arcuate section 34. Thus, the bottom plates 40 of the first arcuate section 32 and the second arcuate section 34 together define a retaining ledge 48 of the collar 30 extending around the spindle 18. The retaining ledge 48 is aligned with and adjacent to the lip 26.

The cutter 24 is coupled to the spindle 18 such that the cutter 24 is exposed in the mowing deck 12 and rotates with the spindle 18. The cutter 24 is retained adjacent to the mowing deck 12 upon the catastrophic failure of the spindle 18 between the mower 14 and the lip 26. The lip 26 may be formed as an integral or assembled extension directly from the spindle 18. Alternatively, an adapter 50 can be used to convert a conventional spindle 18 for use consistent with the assembly 10. The lip 26 may be integrally coupled to and extend from the adapter 50. The adapter 50 is coupled to the coupling portion 22 of the spindle 18 wherein the adapter 50 is positioned between the spindle 18 and the cutter 24. Each of a plurality of cutter connection holes 52 extends through the coupling portion 22 of the spindle 18. Each of a plurality of fastening apertures 54 extends through the adapter 50. Each of a plurality of fastening holes 56 extends through the cutter 24. Each of a plurality of cutter fasteners 58 is positionable to extend through a respective one of the fastening holes 56, an aligned respective one of the fastening apertures 54, and an aligned respective one of the cutter connection holes 52 whereby the cutter 24 is coupled to the spindle 18. An upper surface 60 of the adapter 50 has a socket 62 for receiving a spindle hub 64 extending from the coupling portion 22 of the spindle 18. A lower surface 66 of the adapter 50 has an adapter hub 68 equivalent in shape to the spindle hub 64 extending from the coupling portion 22 of the spindle 18 wherein the lower surface 66 of the adapter 50 is shaped for direct coupling to the cutter 24. The plurality of fastening apertures 54 is evenly spaced and positioned radially around the adapter hub 68 extending from the lower surface 66 of the adapter 50 and the fastening apertures 54 are positioned to align with the plurality of fastening holes 56 in the cutter 24.

In use, the lip 26 provides a physical obstruction to prevent a broken off portion of the spindle 18 from passing through the retainer 28 in the event of catastrophic failure of the spindle 18 at any structural point between the lip 26 and the mower 14. In the event of such failure power is cut off from the spindle 18 and the cutter 24 will remain attached to the mowing deck 12 instead of forcefully ejecting away from the mowing deck 12. Thus, safety is significantly enhanced and the possibility of grievous or mortal injury is significantly reduced if not fully eliminated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cutter retention assembly comprising:
a mowing deck;
a motor coupled to said mowing deck, said mowing deck having a top wall;
a spindle coupled to said mowing deck, said spindle being rotatable by said motor, said spindle extending downwardly relative to said top wall of said mowing deck;
a spindle housing coupled to said mowing deck and extending around said spindle, said spindle having a coupling portion extending from said spindle housing;
a lip being coupled to said spindle, said lip extending radially outward relative to said spindle, said lip being positioned outside of said spindle housing;
a retainer coupled to said spindle housing, said retainer extending around said spindle defining a collar, said collar being positioned adjacent to and aligning with said lip such that said lip is positioned to be retained within said mowing deck by said collar upon catastrophic failure of said spindle; and
a cutter coupled to said spindle such that said cutter is exposed in said mowing deck and rotates with said spindle, said cutter being retained adjacent to said mowing deck upon the catastrophic failure of said spindle between said mower and said lip.

2. The assembly of claim 1, further comprising an adapter, said lip being integrally coupled to and extending from said adapter, said adapter being coupled to said coupling portion of said spindle wherein said adapter is positioned between said spindle and said cutter.

3. The assembly of claim 2, further comprising:
a plurality of cutter connection holes extending through said coupling portion of said spindle;
a plurality of fastening apertures extending through said adapter; and
a plurality of fastening holes extending through said cutter; and
a plurality of cutter fasteners, each said cutter fastener being positionable to extend through a respective one of said fastening holes, an aligned respective one of said fastening apertures, and an aligned a respective one of said cutter connection holes whereby said cutter is coupled to said spindle.

4. The assembly of claim 2, further comprising an upper surface of said adapter having a socket for receiving a spindle hub extending from said coupling portion of said spindle.

5. The assembly of claim 2, further comprising a lower surface of said adapter having an adapter hub equivalent in shape to said spindle hub extending from said coupling portion of said spindle wherein said lower surface of said adapter is shaped for direct coupling to said cutter.

6. The assembly of claim 3, further comprising said plurality of fastening apertures being evenly spaced and positioned radially around an adapter hub extending from a lower surface of said adapter, said fastening apertures aligning with a plurality of fastening holes in said cutter.

7. The assembly of claim 1, further comprising said retainer comprising a first arcuate section and a second arcuate section, said first arcuate section and said second arcuate section being positioned to define said collar extending around said spindle

8. The assembly of claim 7, wherein each of said first arcuate section and said second arcuate section comprises a respective top plate, middle plate, and bottom plate.

9. The assembly of claim 8, further comprising said bottom plate of each of said first arcuate section and said second arcuate section having a concave interior edge being inset relative to concave interior edges of said middle plate and said top plate of each of said first arcuate section and said second arcuate section wherein said bottom plates of said first arcuate section and said second arcuate section together define a retaining ledge of said collar extending around said spindle, said retaining ledge being aligned with and adjacent to said lip.

10. A cutter retention assembly comprising:
a mowing deck;
a motor coupled to said mowing deck, said mowing deck having a top wall;
a spindle coupled to said mowing deck, said spindle being rotatable by said motor, said spindle extending downwardly relative to said top wall of said mowing deck;
a spindle housing coupled to said mowing deck and extending around said spindle, said spindle having a coupling portion extending from said spindle housing;
a lip being coupled to said spindle, said lip extending radially outward relative to said spindle, said lip being positioned outside of said spindle housing;
a retainer coupled to said spindle housing, said retainer extending around said spindle defining a collar, said collar being positioned adjacent to and aligning with said lip such that said lip is positioned to be retained within said mowing deck by said collar upon catastrophic failure of said spindle, said retainer comprising a first arcuate section and a second arcuate section, said first arcuate section and said second arcuate section being positioned to define said collar extending around said spindle, each of said first arcuate section and said second arcuate section comprises a respective top plate, middle plate, and bottom plate, said bottom plate of each of said first arcuate section and said second arcuate section having a concave interior edge being inset relative to concave interior edges of said middle plate and said top plate of each of said first arcuate section and said second arcuate section wherein said bottom plates of said first arcuate section and said second arcuate section together define a retaining ledge of said collar extending around said spindle, said retaining ledge being aligned with and adjacent to said lip;
a cutter coupled to said spindle such that said cutter is exposed in said mowing deck and rotates with said spindle, said cutter being retained adjacent to said mowing deck upon the catastrophic failure of said spindle between said mower and said lip;
an adapter, said lip being integrally coupled to and extending from said adapter, said adapter being coupled to said coupling portion of said spindle wherein said adapter is positioned between said spindle and said cutter;
a plurality of cutter connection holes extending through said coupling portion of said spindle;
a plurality of fastening apertures extending through said adapter;
a plurality of fastening holes extending through said cutter;
a plurality of cutter fasteners, each said cutter fastener being positionable to extend through a respective one of said fastening holes, an aligned respective one of said fastening apertures, and an aligned a respective one of said cutter connection holes whereby said cutter is coupled to said spindle;
an upper surface of said adapter having a socket for receiving a spindle hub extending from said coupling portion of said spindle; and
a lower surface of said adapter having an adapter hub equivalent in shape to said spindle hub extending from said coupling portion of said spindle wherein said lower surface of said adapter is shaped for direct coupling to said cutter, said plurality of fastening apertures being evenly spaced and positioned radially around an adapter hub extending from said lower surface of said adapter, said fastening apertures aligning with a plurality of fastening holes in said cutter.

11. A cutter retention assembly comprising:
a mowing deck;
a motor coupled to said mowing deck, said mowing deck having a top wall;
a spindle coupled to said mowing deck, said spindle being rotatable by said motor, said spindle extending downwardly relative to said top wall of said mowing deck;
a spindle housing coupled to said mowing deck and extending around said spindle, said spindle having a coupling portion extending from said spindle housing;
a lip extending radially outward from said spindle;
a retainer coupled to said spindle housing, said retainer extending around said spindle defining a collar, said collar being positioned adjacent to and aligning with said lip such that said lip is positioned to be retained within said mowing deck by said collar upon catastrophic failure of said spindle; and
a cutter coupled to said spindle such that said cutter is exposed in said mowing deck and rotates with said spindle, said cutter being retained adjacent to said mowing deck upon the catastrophic failure of said spindle between said mower and said lip.
